(19) United States
(12) Patent Application Publication
(10) Pub. No.: US 2002/0075848 A1
(43) Pub. Date: Jun. 20, 2002

(54) Local switch attached telephony access node

(76) Inventors: John E. Lumsden, Toronto (CA); John C. Myers, Toronto (CA); Rene M. Mueller, Toronto (CA)

Correspondence Address: G. RONALD BELL & ASSOCIATES, P O BOX 2450, POSTAL STATION D, OTTAWA, ON, K1P 5W6, CA

(21) Appl. No.: 09/739,978

(22) Filed: Dec. 20, 2000

(51) Int. Cl. H04L 12/66

(52) U.S. Cl. 370/352; 370/401; 370/396

(57) ABSTRACT

The present invention seeks to provide a bridge between traditional TDM PBX/KTS messaging and current IP-based messaging, allowing effective deployment of a hosted service in a transitional network that still requires TDM access via the PSTN. According to the present invention, the centralized messaging system of the prior art is decomposed into a back end cluster and a plurality of telephony access nodes (TANs). Each of the TANs will: terminate media and call processing from an associated local telephony switch; contain the service logic for the messaging application; and interact with the back end cluster. This provision permits a user to perform communications on a local telephony access node without making a call over the public switched network. However, a switch is also provided at each telephony access node to permit user access to the telephony access node.

### FIELD OF INVENTION

The present invention relates in general to messaging systems, and in particular to user access to services offered within such messaging systems.

### BACKGROUND OF INVENTION

Many enterprises employ a plurality of messaging systems in order to meet their business needs. Such messaging systems may include unified messaging systems and unified communications systems. In the prior art, it was customary for enterprises to deploy each separate messaging system on a separate switch, as illustrated in FIG. 1A. Each of these switches could be either Private Branch Exchange (PBX) or Key Telephone System (KTS). However, because of many drawbacks relating to arrangements such as in FIG. 1A, some enterprises were led to adopt another prior art arrangement comprising a centralized messaging system, as illustrated in FIG. 1B. The three main advantages of a system such as that in FIG. 1B are in the areas of functionality, administration and outsourcing. In terms of functionality, a centralized messaging system permits easier maintenance of distribution lists that span sites; also, callers are no longer required to know specialized prefix codes to address “off-node” subscribers. The centralized administration associated with a centralized messaging system affords economies of scale to an enterprise in administering one central system, as opposed to administering separate systems at multiple sites. Enterprises are also considering the alternative of outsourcing, i.e. turning over the provisioning, maintenance and administration of their systems to third parties, which is significantly simpler in the case of a centralized messaging system.

However, there are two principal drawbacks to such a centralized system: signaling and toll charges. Consider the case of two subscribers that are both served by a single switch. Subscriber A calls Subscriber B, who is not present; as such, Subscriber A is forwarded to the centralized messaging system to leave a message for subscriber B. As the call is forwarded to the messaging system, the switch must transmit the fact that the call has been forwarded from Subscriber B, thereby allowing the centralized messaging system to answer the call with a Call Answering session on behalf of Subscriber B. Subscriber B's switch must subsequently be informed that there is a message waiting for Subscriber B, so that it may activate Subscriber B's Message Waiting Indication.

While some signaling systems (such as ISDN, PRI NI2) employed between the Subscriber B's local switch and the messaging system offer support for the afore-mentioned capabilities, the deployment of such capabilities is both limited and costly. Secondly, even though Subscriber A is leaving a message for someone who is served by a local switch, the necessity of placing the call to the centralized messaging system can result in a first toll charge when Subscriber A leaves the message, and a second toll charge when Subscriber B calls the centralized messaging system to retrieve the message. These toll charges can arise when a company with offices spread across a large geographic area (e.g. the United States) employs a centralized system, or even when “local” calls are made in a jurisdiction such as Europe where there is local metered service.

Therefore, it would be desirable to have a method and a system that would address the above shortcomings of existing centralized messaging systems.

### SUMMARY OF THE INVENTION

It is an object of the present invention to provide a bridge between traditional TDM PBX/KTS messaging and current IP-based messaging, allowing effective deployment of a hosted service in a transitional network that still requires TDM access via a public switched telephone network (PSTN).

The present invention seeks to decompose the centralized messaging system of the prior art into a back end cluster and a plurality of telephony access nodes (TANs). Each of the TANs will: terminate media and call processing from an associated local telephony switch; contain the service logic for the messaging application; and interact with the back end cluster. Connectivity from the TAN to the back end cluster is made via the Internet Protocol Wide Area Network allowing user access to the centralized message store without making a call over the Public Switched Telephony Network. However, a switch is also provided at each telephony access node to permit subscriber access to the TAN.

According to one aspect of the invention, there is provided a messaging system comprising: a back end cluster for providing services to users of said messaging system; a plurality of telephony access nodes for providing said users with local access to said services via a wide area network that connects said back end cluster to said plurality of telephony access nodes; and a plurality of switches, each of which is connected to one of said plurality of telephony access nodes for providing said users with access to said services.

According to another aspect of the invention, there is provided a method of deploying a hosted service in a network, said method comprising the steps of: providing said service to the users of said network by means of a back end cluster; providing local access to said hosted service via a wide area network that connects said back end cluster to a plurality of telephony access nodes; each of said plurality of switches being connected to one of said plurality of telephony access nodes.

### BRIEF DESCRIPTION OF THE DRAWINGS

Embodiments of the invention will now be described with reference to the accompanying drawings, in which:

FIG. 1A illustrates a prior art system employing a separate messaging system per switch;

FIG. 1B illustrates a prior art system employing a centralized messaging system accessed via the Public Switch Telephony Network (PSTN).

FIG. 2 illustrates a distributed messaging system according to an embodiment of the present invention;

FIG. 3 illustrates a message flow showing a Call Answering session in a system according to an embodiment of the present invention; and

FIG. 4 illustrates a message flow showing a Message Retrieval session in a system according to an embodiment of the present invention.

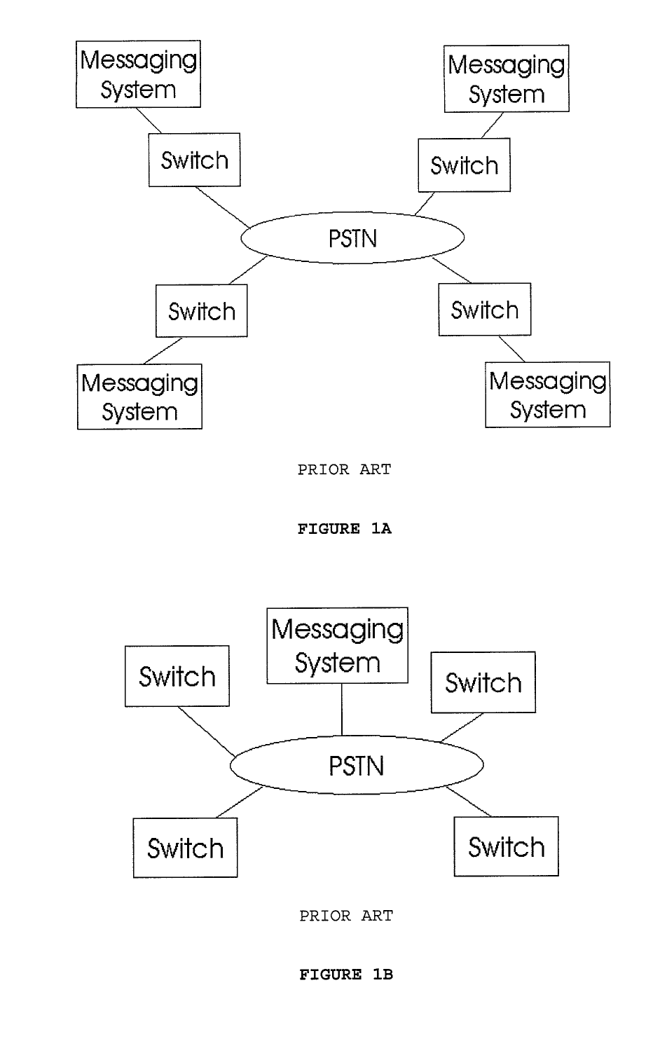

### DETAILED DESCRIPTION OF THE INVENTION

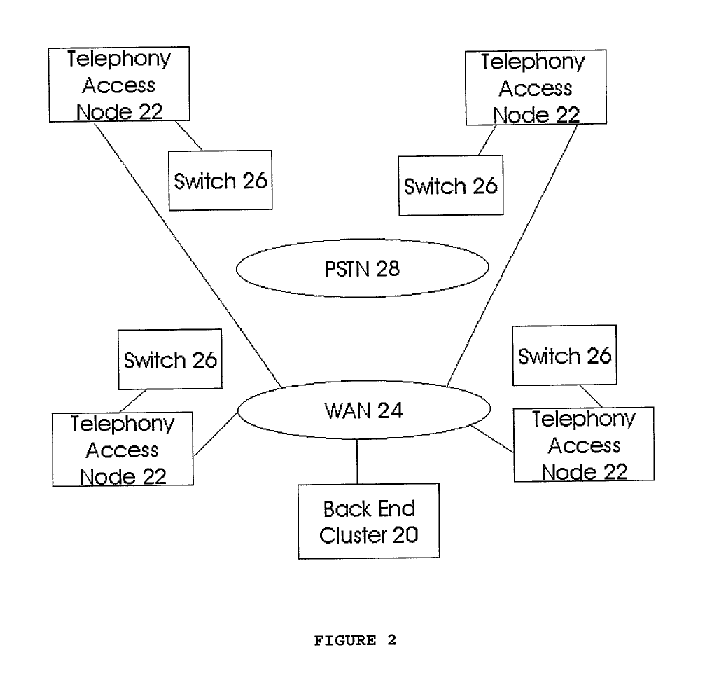

The basis of the present invention is to decompose a monolithic centralized messaging system of the prior art into a Back End Cluster plus a plurality of Telephony Access Nodes (TANs) as shown in FIG. 2. A single logical Back End Cluster 20 services the entire messaging system. Of course, this logical Back End Cluster may consist of multiple physical instances of Back End Cluster components in order to provide redundancy for high availability. In a preferred embodiment, the Back End Cluster 20 would include a common directory (containing all subscriber information), message store (containing all of the subscriber's messages) plus any other common functions. The Back End Cluster 20 would be visible to each Telephony Access Node 22 via an IP-based Wide Area Network 24. Each of the Telephony Access Nodes 22 is provisioned at a local telephony switch 26. Each of the Telephony Access Nodes 22 terminate the media and call processing from the associated local telephony switch 26, contain the service logic for the messaging application, and interact with the Back End Cluster 20.

In a system according to FIG. 2, consider the case where Subscriber A is transferred to the messaging system when Subscriber B has not answered a call. The necessary transfer would be a local transfer to the TAN local to the switch. Signaling to the TAN is performed in the switch's local, native signaling format. The TAN records the message for Subscriber B, and then transfers the message to the centralized message store component of the Back End Cluster 20 via the WAN 24.

Therefore, in contrast to prior art systems, a system according to this embodiment of the present invention does not cause a call out over the PSTN 28, with the attendant signaling and possible toll costs associated therewith. Similarly, when Subscriber B calls to retrieve his message, the call is a local call that terminates on the TAN local to the switch. The TAN 22 will retrieve any messages for Subscriber B from a centralized message store within the Back End Cluster 20 via the WAN 24, and play the messages back to Subscriber B.

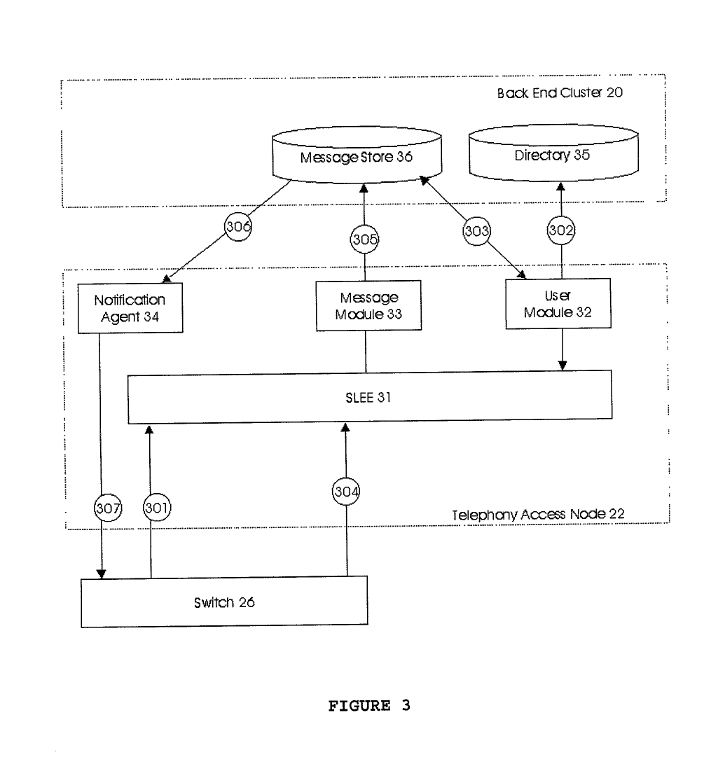

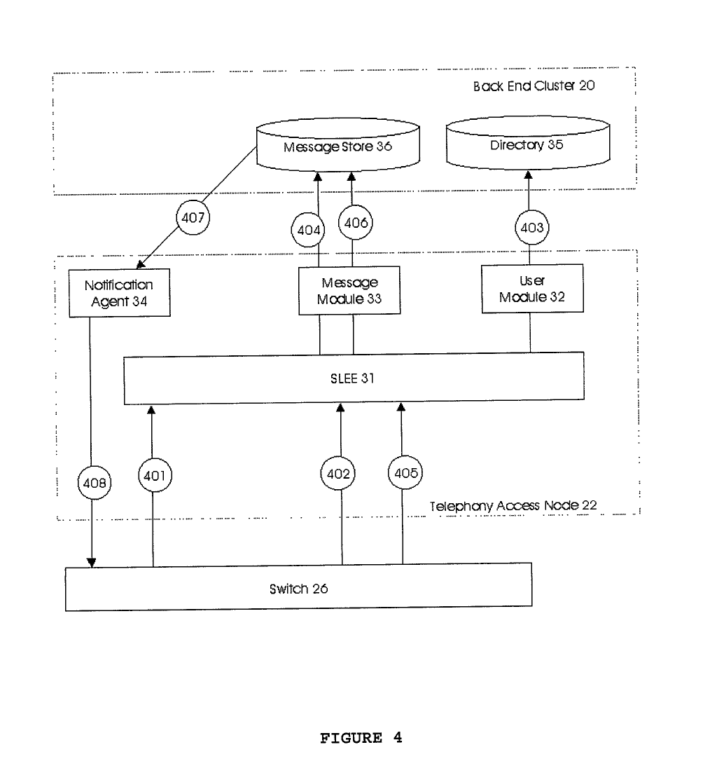

In a messaging system such as the one shown in FIG. 2, two services among those most commonly used would be call answering and message retrieval. The steps involved in performing these two exemplary services in a system according to an embodiment of the present invention will each be described in further detail with reference to FIGS. 3 and 4.

FIG. 3 illustrates a message flow showing a Call Answering session in a system according to an embodiment of the present invention. This scenario may occur when Subscriber A calls Subscriber B, who does not answer. The switch 26 forwards the call to the local TAN 22 as step 301. The manner in which the switch presents the call to the TAN is switch-specific. This message will contain three data elements: the original called number (Subscriber B's number), the calling number (Subscriber A's number) and the redirect number (the messaging service directory number). In this embodiment, the messaging service logic unit is Service Logic Execution Environment (SLEE) 31. The SLEE views these three data elements and concludes this is a Call Answering call. In step 302, the SLEE 31 looks up the subscriber information associated with the original called number. This lookup is performed by means of a query issued via user module 32 to directory 35. This query is made over the WAN to the directory 35, located in the Back End Cluster 20. This will identify who the subscriber is, as well as identify their greeting and the location where the incoming message should be stored. A data structure representing the subscriber information is held temporarily in the user module 32. The user's greeting is stored in Subscriber B's inbox as a special message type. In step 303, the user's greeting is sent to the SLEE 31 via the WAN. Subscriber B's greeting (e.g. “Hi, this is Jim and you've reached my voicemail . . . ”) is relayed to the SLEE 31, where it is played to the caller, Subscriber A. Subscriber A leaves a voice message, which is recorded and stored temporarily on the local TAN. In step 304, Subscriber A hangs up after leaving his message.

In step 305, the recorded message is sent via message module 33 and is placed in Subscriber B's inbox, located in message store 36 within the Back End Cluster 20. If it is determined that the user's Message Waiting Indication is to be turned on (which is assumed for this example), a Message Waiting Indication request is sent to notification agent 34 on behalf of Subscriber B in step 306. The notification agent 34 tells the switch 26 to activate Subscriber B's message waiting indication in step 307.

In an alternate embodiment, if Subscriber B has short message system (SMS) notification, the back end cluster 20 would pass this notification to an SMS notification agent and not engage the TAN 22.

As has been mentioned previously, according to this embodiment of the invention, all of the interaction between the switch and the messaging system is made on the local TAN, resulting in no calls being made over the PSTN. All of the interaction between the local TAN and the centralized Back End Cluster is made over the IP Wide Area Network.

FIG. 4 illustrates a message flow showing a Message Retrieval session in a system according to an embodiment of the present invention. This scenario may occur when Subscriber B phones the messaging service directory number directly in order to pick up his messages. The initial steps in this message flow are similar to the case of FIG. 3. The switch 26 forwards an incoming call to the local TAN 22 in step 401. This message will contain three data elements: the original called number (messaging service directory number), the calling number (Subscriber B's number) and the redirect number (null). In this embodiment, the messaging service logic is Service Logic Execution Environment (SLEE) 31. The SLEE 31 notes that this was a call made directly to the messaging service, and initiates a message retrieval session. The messaging system prompts for the caller's mailbox and password, which the caller supplies in step 402. The service logic takes the mailbox and password, and in step 403 interacts with the subscriber information stored in the back end cluster's directory 35 to first identify the subscriber, then validate the subscriber and retrieve subscriber information such as the location of their inbox in message store 36. After validating the subscriber (verifying that the password supplied was correct), in step 404 the service logic will query the contents of the subscriber's inbox stored in the back end cluster message store 36 via the message module 33. A mailbox summary is then played for the subscriber. In step 405, the subscriber will indicate a request to hear a message. In step 406, the requested message is retrieved by the SLEE 31 from the message store 36 via the message module 33, and the message is read to the subscriber. In the case where the subscriber's Message Waiting Indication should be turned off, in step 407 a request to turn off a message waiting indication is sent to notification agent 34 within local TAN 22. In step 408, the notification agent 34 sends a request to the switch 26 requesting that Subscriber B's message waiting indication be turned off.

Once again, all of the interaction between the switch and the messaging system is made on the local TAN, resulting in no calls made over the PSTN. All of the interaction between the local TAN and the centralized Back End Cluster is made over the IP Wide Area Network.

What is claimed is:

1. A network for hosting a service offered to users wherein said users require different types of access to said service, said network comprising:
a back end cluster for providing said service to the users of said network;
a plurality of telephony access nodes for providing said users with local access to said service via a wide area network that connects said back end cluster to said plurality of telephony access nodes; and
a plurality of switches, each of which is connected to one of said plurality of telephony access nodes for providing said users with access to said service.

2. A network according to claim 1 wherein said hosted service is a messaging system.

3. A network according to claim 2 wherein said messaging system is a unified messaging system.

4. A network according to claim 2 wherein said messaging system is a unified communications system.

5. A network according to claim 1 wherein one of said plurality of switches is a private branch exchange.

6. A network according to claim 1 wherein one of said plurality of switches is a key telephone system.

7. A network according to claim 2 wherein one of said plurality of switches is a private branch exchange.

8. A network according to claim 2 wherein one of said plurality of switches is a key telephone system.

9. A method of deploying a hosted service in a network, said method comprising the steps of:
providing said service to the users of said network by means of a back end cluster; and
providing local access to said hosted service via a wide area network that connects said back end cluster to a plurality of telephony access nodes.

10. A method according to claim 9 wherein said hosted service is a messaging system.

11. A method according to claim 10 wherein said messaging system is a unified messaging system.

12. A method according to claim 10 wherein said messaging system is a unified communications system.

13. A method according to claim 9 wherein one of said plurality of switches is a private branch exchange.

14. A method according to claim 9 wherein one of said plurality of switches is a key telephone system.

15. A method according to claim 10 wherein one of said plurality of switches is a private branch exchange.

16. A method according to claim 10 wherein one of said plurality of switches is a key telephone system.
